(19) United States
(12) Patent Application Publication
(10) Pub. No.: US 2011/0078096 A1
(43) Pub. Date: Mar. 31, 2011

(54) CUT CARD ADVERTISING

(76) Inventor: Barry B. Bounds, Littleton, CO (US)

(21) Appl. No.: 12/889,174

(22) Filed: Sep. 23, 2010

Related U.S. Application Data
(60) Provisional application No. 61/245,904, filed on Sep. 25, 2009.
(60) Provisional application No. 61/251,190, filed on Oct. 13, 2009.

(51) Int. Cl. G06Q 90/00; G09F 1/02; A63F 1/00

(52) U.S. Cl. 705/500; 40/124.01; 273/295

(57) ABSTRACT

The present disclosure sets forth a method of advertising using a cut card. In one embodiment of the present application, a method for providing an advertising message on a cut card during a card game is described. A cut card, including an advertising message region, is provided during a card game. The cut card is then used during at least one shuffle of the card game. During the shuffle, a camera is focused on the shuffle from an angle such that the advertising message is viewed in the advertising message region. Other embodiments of the present application disclose a cut card for use during a card game. The cut card comprises an advertising message region, wherein the advertising message region provides an area for viewing at least one advertising message, and wherein each side of the cut card provides one advertising region.

### RELATED APPLICATIONS

This application claims priority to U.S. Provisional App. Ser. No. 61/245,904, entitled “Cut Card Advertising” filed on Sep. 25, 2009; and U.S. Provisional App. Ser. No. 61/251,190, entitled “Cut Card Advertising” filed on Oct. 13, 2009, the entire disclosures of all of which are hereby incorporated herein by reference.

### INTRODUCTION

The cut card is used throughout the dealing process of card games like poker. The typical dealer shuffles the deck over 30 times per hour and the cut card is used during the shuffling process and also when it is on the bottom of the deck. In televised poker events it is common to see the cut card from both overhead shots and during the shuffling and dealing process from side cameras. This visibility to large television audiences as well as to the players and dealers presents an opportunity to deliver an advertising message.

The approach would be to infuse a printed message on both sides of the cut cards that delivers an advertising message or brand information. This would not be intrusive in the shuffling and dealing process but would be a valuable advertising space that is not currently being utilized.

The ink on the cards or imbedded into the cut card would be non-transferable to other surfaces such as the table, cards, players or dealers. The ink would not be water or alcohol soluble.

### BRIEF DESCRIPTION OF THE DRAWINGS

The following drawing figures, which form a part of this application, are illustrative of embodiments systems and methods described below and are not meant to limit the scope of the technology in any manner.

FIG. 1 is a plan view of an example cut card as described herein.

FIG. 2 is an exemplary flow for providing advertising using cut cards during a card game.

FIG. 3 is an illustrative computing network.

FIG. 4 is an illustrative flow of a process for ordering a cut card on a website.

### DETAILED DESCRIPTION

The present disclosure sets forth embodiments of a cut card and methods of advertising using a cut card. A cut card is used in various card games such as poker. The cut card is a special card-shaped object, usually made of a different material than the actual playing cards, used to indicate the location in the deck at which the deck should be cut and to cover the bottom card so as to prevent it from being exposed. The cut card is typically a separate device than the other cards in the deck and should be appear to be physically different.

In one embodiment of the present disclosure, a method for providing an advertising message on a cut card during a card game is described. A cut card, including an advertising message region, is provided during a card game. The cut card is then used during at least one shuffle of the card game. During the shuffle, a camera is focused on the shuffle from an angle such that the advertising message is clearly seen.

Other embodiments of the present disclosure describe a cut card for use during a card game. The cut card comprises an advertising message region, wherein the advertising message region provides an area with at least one advertising message, and wherein one or both sides of the cut card provides an advertising region.

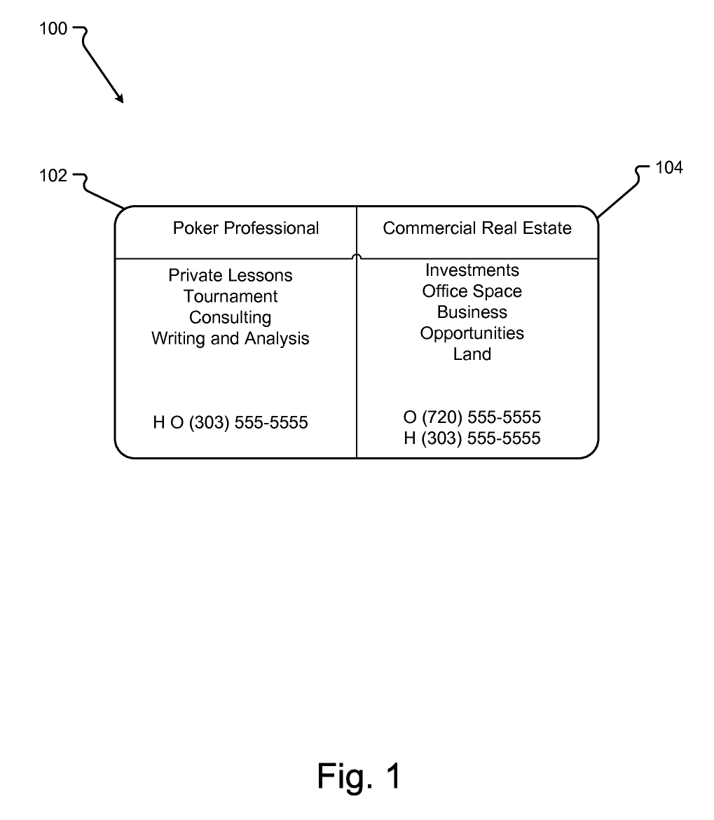

FIG. 1 depicts and exemplary cut card 100 to be used to display an advertising message. The cut card 100 may be constructed of a thin material such as a plastic. The plastic cut card 100 size matches the size and shape of a single playing card being used in the game. The surface of the cut card 100 is smooth on one side and rough on the other but will not damage the playing cards under normal use. The typical cut cards dimensions are length 3.5 mm (millimeters), width 2.5 mm, and a thickness of 0.017 mm. Dimensions will vary by the size of the playing cards in each venue but the sizes will not vary significantly. The size must be adequate to support the shuffling cutting and dealing process and still provide a surface area for the advertising message. Multiple colors will be available including white, yellow, green, red, blue and black.

In an embodiment, the dimensions of a cut card may be based on, but not exactly the same, as the dimensions of the cards for which the cut card is intended to be used. For example, one or more of the dimensions of a cut card may be several millimeters larger than the cards to facilitate the dealer's manipulation of the cut card during the shuffle.

In the technology described herein, an advertisement or message is included in an advertising region of the cut card. Each side of the cut card 100 includes an advertising region for displaying at least one advertising message. As depicted in cut card 100, two advertising message, 102 & 104, are displayed in the advertising region on the visible side of cut card 100. Displaying an advertising message in this manner would not be intrusive in the shuffling and dealing process but would be a valuable advertising space that is not currently being utilized.

In one embodiment of the technology, the approach would be to infuse a printed message on both sides of the cut cards that delivers an advertising message or brand information. In the embodiment, the ink on the cards or embedded into the cut card is non-transferable to other surfaces such as the table, cards, players or dealers. For example, the ink should not be water or alcohol soluble. Alternatively, any manner of printing, embossing or other technology may be used to place the advertisement or message on the cut card although those methods that do have the potential to mark or damage the cards and that do not interfere with the typical use of the cut cards are preferred.

In an embodiment, plastic cut cards may be created in various colors or combinations of colors. Subsequently or concurrently to manufacture, a process to infuse ink into the plastic with the advertiser's message in contrasting colors to be readily visible to both television and players may be performed. In an embodiment, the ink will be permanent and will not readily transfer to other surfaces.

Cut cards may be marketed and distributed in various ways. The cut cards could be marketed to operating casinos, general gaming industry companies and anyone wanting to target the players and viewers of card games either live or on television. Cut card advertising can also be used to deliver advertisement during home card games. For example, professional Poker players who wanted to advertise that they offered poker lessons could use this form of advertising to get their message out. The cut card would become part of a home game and deliver continuing value to the advertiser.

Cut cards could be given away as promotional items or sold individually. In addition, one or more cut cards could be packaged with a deck of cards and sold or given away as a set. In this aspect a cut card is not the same as and should not be confused with a deck's wildcard as the cut card is made of a different material from the cards in the deck and need not share the back artwork with the cards of the deck.

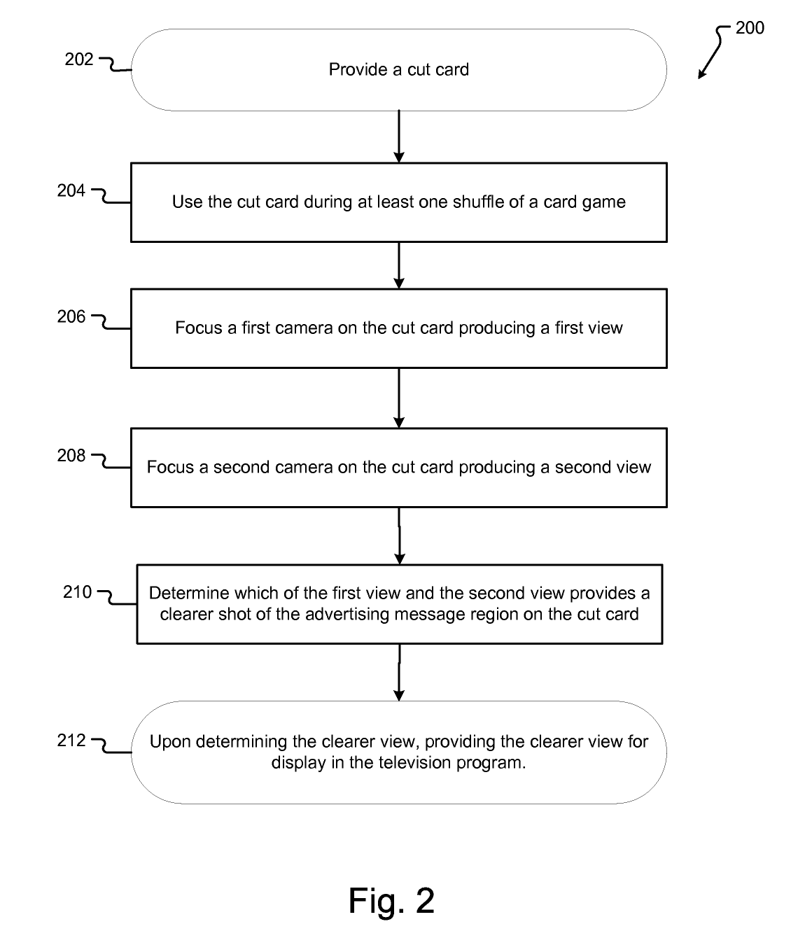

FIG. 2 illustrates an embodiment of a method 200 for providing advertising using cut cards during a card game. The method 200 is described in terms of the exemplary card game of poker, although the method 200 is suitable for any card game. During an average televised poker tournament the cut card is prominently displayed approximately 28-33 times every hour (during each shuffle of the deck) for approximately 18-30 seconds each time. During these periods, the attention of the players, spectators and, typically, the camera is focused directly on the deck of cards being shuffled, and thus on the cut card.

The method begins at provide operation 202 when a cut card is provided. As described with reference to FIG. 1, the cut card includes an advertising message region displaying at least one advertising message. In another embodiment, the advertising message region of the cut card may be blank allowing an advertising message to be digitally inserted later so that viewers of the streaming video could see advertisements generated in real time by the broadcaster on the cut card. This could allow different advertisements to be displayed to viewers in different locations or on different feeds of the televised game by digitally enhancing the feeds with different advertisements. Once the cut card is provided, flow proceeds to a use operation 204.

At use operation 204, the cut card is used during at least one shuffle or other card or deck manipulation step of the card game. For example, during a shuffle, a deck of cards is cut and the bottom card of the exposed cut portion of the deck is covered with a cut card. Once the cut card is used, flow proceeds to a focus operation 206.

At focus operation 206, a first camera is focused on the cut card producing a first view. Multiple cameras are often used during competitive poker games. These cameras are often placed at different angles. For example, one camera may be placed at a “birds' eye” view to provide an overall view of the game. Another camera may be placed at or below table height to provide a view of a player's hand, e.g., through a clear table surface. Another camera may be placed from a side angle to display the player's reactions. As will be appreciated, numerous other cameras and camera angles can be utilized during a poker game. Once a first camera is focused on the cut card producing a first view, flow proceeds to a second focus operation 208.

At the second focus operation 208, a second camera is focused on the cut card producing a second view. As discussed with reference to operation 206, many cameras are used during competitive poker games producing a multitude of views. Once a second camera is focused on the cut card producing a second view, flow proceeds to a determine operation 210.

At determine operation 210, a determination is made as to which of the first view and the second view provides a clearer shot of the advertising message region on the cut card. This determination could be made by the producers of the poker game, the network, or any other entity with control over the television program. The determination could be made by sight, algorithmically, or by any other method known in the art for determining clarity in a camera shot. Once the determination is made, flow proceeds to a transmission operation 212.

At transmission operation 214, the clearer view of the advertising message region is provided for display in the television program. In one embodiment, an advertiser may be billed according to the number of times its advertisement appears in the television program. Flow ceases once the view of the advertising message region is provided. In embodiments in which a blank cut card is to be digitally enhanced with an advertisement, the transmission operation 214 may include sub-operations of selecting an advertisement for use (such as based on the target audience of the particular transmission), retrieving the advertisement from a digital repository of available advertisements and digitally modifying the stream of video data so that the advertisement is visible on top of the cut card.

Alternate embodiments of the method will be immediately suggested to those of skill in the art. For example, a simpler embodiment of a method can be created by omitting the second focus operation and determination operation. In yet another embodiment, both camera views may be transmitted side by side to increase the visibility of the advertisement.

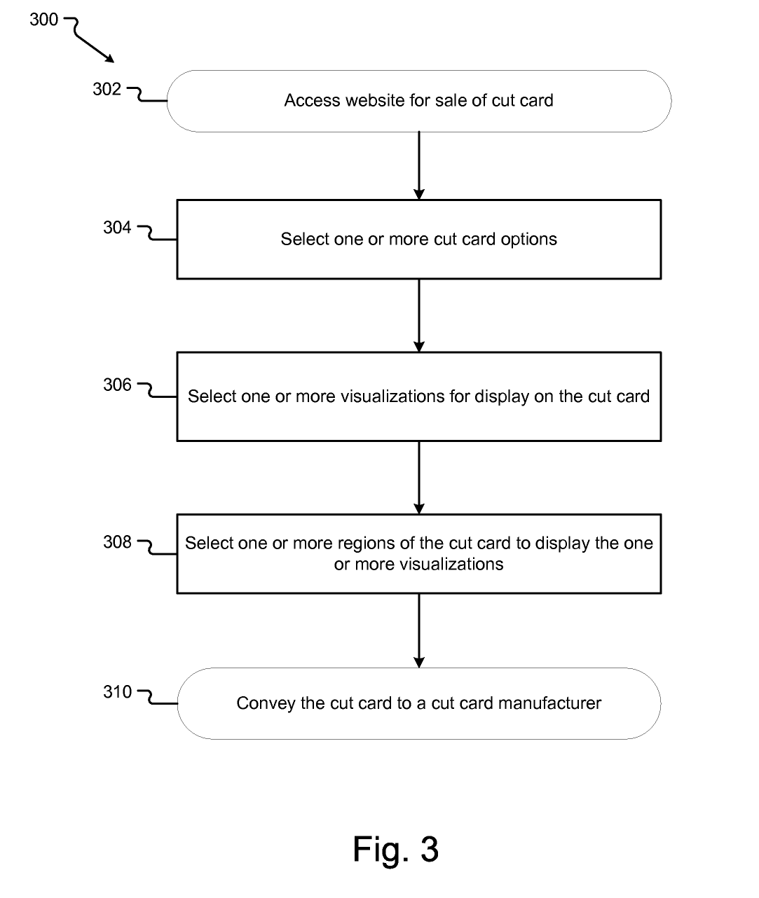

FIG. 3 illustrates an embodiment of a method for the design and sale of cut cards automated through a website. The method 300 commences at access operation 302, at which a party desiring cut cards with advertisements as described above accesses a website for designing and ordering cut cards via the internet or other communication network. The servers hosting the website could transfer the web pages to the client computer necessary for the client to design and order individualized cut cards. Flow then proceeds to cut card selection a cut card select operation 304.

At cut card selection operation 304, the user accessing the website selects one or more cut card options. In one embodiment, a client may, through the web pages of the website, select the following options: cut card color (e.g., red, blue, yellow, etc.), cut card material (plastic, metal, etc.), surface treatment (matte, gloss, semi-gloss, etc.), thickness, quantity, and cut card size (e.g., a user may be prompted to select one of any standard playing card size such as the KEM and Copag card sizes or may, alternately, provide the exact dimensions for the cut card). Other options may also be provided for individualizing the client's cut cards. Flow then proceeds to an advertisement selection operation 306.

At advertisement selection operation 306, the user may select one or more visualizations for display on the cut card. In one embodiment, a visualization may include graphics files, files (e.g. jpg, gif, etc.) and/or text. The graphics file can contain any graphic desired by the client to be put on the cut card. In an embodiment, vector graphics file types may be preferred in order to make manipulating the file to fit the size of the cut card easier. The graphic may be displayed back to the client and the client may then use the tools supplied by the web page to resize and position the graphic on the cut card. The website may further allow the client to enter text for addition to the cut card in addition to or instead of the graphic file(s). In an embodiment, each region of the card may be identified and the client may be allowed to enter text and select a text color, size and font. This also may be displayed to the client for approval. Flow then proceeds to a region selection operation 308.

At region selection operation 308, the user selects one or more regions of the cut card to display the one or more visualizations. In one embodiment, to facilitate positioning of text and graphics files on a cut card, the cut card may be divided into different sections allowing the client to select where and how on the cut card text and graphics should appear. For example, in FIG. 1 each line of text may correspond to a different pre-defined section on the cut card. Alternatively, the sections may be defined as regions such as the four regions separated by the black lines on the card. These are but two examples of how text and graphics could be positioned on a cut card and the reader will understand that any suitable method may be used. Flow then proceeds to a finalize order operation 310.

At finalize operation 310, the created cut card information is conveyed to a cut card manufacturer once the user has approved the final design. The cut card information is conveyed over a network to a cut card manufacturer. The cut cards then are manufactured, sent to the user and the user is billed.

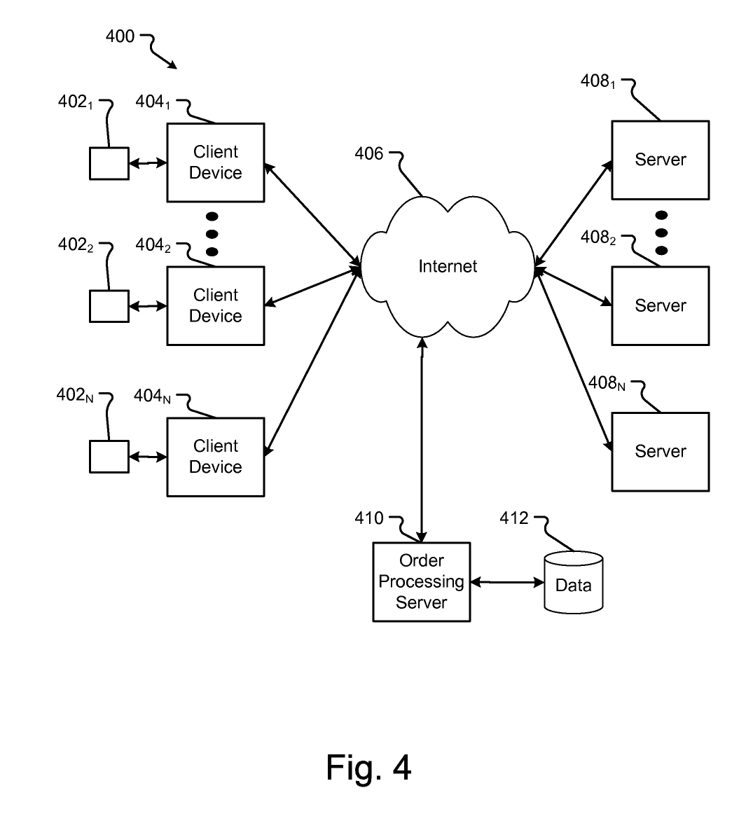

FIG. 4 illustrates a general overview of an information retrieval and communication network 400 suitable for performing the sales method described in FIG. 3, above. FIG. 4 illustrates an embodiment of ecommerce network including an order processing server 410, client devices 404₁ to 404_{N}, and remote servers 408₁ to 408_{N} according to an embodiment of the present invention. In computer network 400, clients 404₁ to 404_{N} are coupled through the Internet 406, or other communication network, to order processing server 410 and servers 408₁ to 408_{N}. Only one order processing server 410 is shown, but it is understood that more than one order processing server can be used, either individually or in a distributed manner, and that other servers providing additional functionality may also be interconnected to any component shown in network 400 either directly, over a LAN or a WAN, or over the Internet. Several elements in the system shown in FIG. 4 are conventional, well-known elements that need not be explained in detail here. For example, each client device 404 could be a desktop personal computer, workstation, cellular telephone, personal digital assistant (PDA), laptop, or any other device capable of interfacing directly or indirectly with the Internet. Each client 404 typically runs a browsing program, such as Microsoft's Internet Explorer, Netscape Navigator or the like, or a micro-browser such as a WAP enabled browser in the case of a cell phone, PDA or other handheld wireless devices, allowing a user of client 404 to browse pages and forms available to it from order processing server 410, servers 408₁ to 408_{N} or other servers over Internet 406. Each client device 404 also typically includes one or more user interface devices 402, such as a keyboard, a mouse, touch screen, pen or the like, for interacting with a graphical user interface (GUI) provided by the browser on a monitor screen, LCD display, etc., in conjunction with pages and forms provided by order processing server 410, servers 408₁ to 408_{N} or other servers. The present disclosure is suitable for use with the Internet, which refers to a specific global Internetwork of networks. However, it should be understood that other networks can be used instead of the Internet, such as an intranet, an extranet, a virtual private network (VPN), a non-TCP/IP based network, any LAN or WAN or the like.

According to one embodiment as will be described in more detail below, order processing server 410 and any related components are operator configurable using an application including computer code-run using a central processing unit such as an Intel Pentium processor or the like. Computer code for operating and configuring order processing server 410 as described herein is preferably stored on a hard disk, but the entire program code, or portions thereof, may also be stored in any other memory device such as a ROM or RAM, or provided on any media capable of storing program code, such as a compact disk medium, a floppy disk, or the like. Additionally, the entire program code, or portions thereof may be downloaded from a software source to order processing server 410 over the Internet as is well known, or transmitted over any other conventional network connection as is well known, e.g., extranet, VPN, LAN, etc., using any communication medium and protocol as are well known. Additionally, portions of the program code may be downloaded or provided to client device 404 and executed on client device 404.

Those skilled in the art will recognize that the methods and systems of the present disclosure may be implemented in many manners and as such are not to be limited by the foregoing exemplary embodiments and examples. While various embodiments have been described, various changes and modifications may be made which are well within the scope of the present disclosure. For example, a cut card need not be of uniform thickness as described herein as long as the edges are the appropriate thickness to allow easy cutting of a deck without damage to the deck. Thus, the edges may be slightly thinner than the center of the cut card in order to facilitate the cutting of the deck and reduce wear to edges of the playing cards. As another example, a cut card could include any type of material, holographic element or thin electronic display that allows for the message on the cut card to change depending on time or viewing angle. Numerous other changes may be made which will readily suggest themselves to those skilled in the art and which are encompassed in the spirit of the disclosure.

What is claimed is:

1. A method for providing an advertising message on a cut card during a card game, the method comprising:
providing the cut card, the cut card including an advertising message region displaying at least one advertising message;
using the cut card during at least one shuffle of the card game; and
during the at least one shuffle, focusing a camera on the shuffle from an angle such that the least one advertising message is viewed in the advertising message region of the cut card.

2. The method of claim 1, wherein the advertising message region may include more than one advertising message.

3. The method of claim 1, wherein the cut card is made of plastic.

4. The method of claim 1, wherein focusing the camera on the shuffle further comprises:
focusing a first camera on the cut card producing a first view; and
focusing a second camera on the cut card producing a second view.

5. The method of claim 4, further comprising:
determining which of the first view and the second view provides a clearer shot of the advertising message region on the cut card.

6. The method of claim 1, wherein the providing operation further comprises:
digitally inserting at least one of the advertising messages on to a blank advertising message region after focusing the camera on the shuffle.

7. A cut card for use during a card game comprising:
a sheet of material having dimensions selected based on dimensions of playing cards used in the card game;
an advertising message region, wherein the advertising message region provides an area for viewing at least one advertising message, and wherein each side of the cut card provides one advertising region; and
at least one advertising message within the advertising region of the cut card.

8. The cut card of claim 7, further comprising two advertising messages in the advertising region.

9. The cut card of claim 8, wherein the advertising messages are different.

10. The cut card of claim 7, wherein the material is made of plastic.

11. The cut card of claim 7, wherein the cut card is the same size as the playing cards.

12. The cut card of claim 7, wherein the cut card is colored differently from the other cards in the deck.

13. The cut card of claim 7, wherein the cut card has at least one dimension that is slightly larger than that of a playing card.

14. A deck of playing cards comprising:
a predetermined number of playing cards; and
at least one cut card having:
an advertising message region, wherein the advertising message region provides an area for viewing at least one advertising message, and wherein each side of the cut card provides one advertising region; and
at least one advertising message within the advertising region of the cut card.

15. The cut card of claim 14, further comprising two advertising messages in the advertising region.

16. The cut card of claim 15, wherein the advertising messages are different.

17. The cut card of claim 14, wherein the cut card is made of a material different from that of the playing cards.

18. The cut card of claim 14, wherein the cut card has dimensions selected based on dimensions of the playing cards.

19. The cut card of claim 14, wherein the cut card is colored differently from the playing cards in the deck.

20. The cut card of claim 14, wherein the cut card has at least one dimension that is slightly larger than that of a playing card.
